(19) United States
(12) Patent Application Publication
(10) Pub. No.: US 2007/0164006 A1
(43) Pub. Date: Jul. 19, 2007

(54) Method for operation of a welding unit welding unit and welding torch for such a welding unit

(76) Inventors: Andreas Burgstaller, Eberstalzell (AT); Helmut Friedl, Sipbachzell (AT); Manfred Wittmann, Rutzenmoos (AT)

Correspondence Address: WILLIAM COLLARD;COLLARD & ROE, P.C., 1077 NORTHERN BOULEVARD, ROSLYN, NY, 11576, US

(21) Appl. No.: 11/596,050

(22) PCT Filed: May 11, 2005
(86) PCT No.: PCT/AT05/00157

§ 371 Date: Nov. 9, 2006

(30) Foreign Application Priority Data
May 14, 2004 (AT) A 854/2004

(51) Int. Cl. B23K 9/095; B23K 9/10

(52) U.S. Cl. 219/130.01

(57) ABSTRACT

The invention relates to a method for operation of a welding unit (1), for the execution of welding processes with a welding device (2) and a welding torch (10), whereby operational states for the welding processes are recorded and, depending on the operational state, vibrations which may be felt are generated and a welding unit (1) and a welding torch (10), for carrying out said method. According to the invention, the possibility of providing feedback about particular operational states to people involved in the welding process, in particular, the welder, without the same having to look away from the welding spot or the arc (15) may be achieved, whereby, in particular, the welding current (I) or the welding voltage (V) are modulated, depending on the operational state, to generate acoustic vibrations in the arc occurring during welding, or, depending on the operational state, mechanical vibrations are generated. The vibrations can also be felt by the welder without looking away from welding spot or the arc (15).

The invention relates to a method for operating a welding device for the execution of welding processes, including a welding apparatus and a welding torch, wherein operating states of the welding processes are detected and vibrations perceptible by persons are generated as a function of said operating states.

The invention further relates to a welding device for the execution of a welding process, including a welding apparatus and a welding torch connected with the welding apparatus as well as a device for detecting operating states of the welding process, wherein a device for generating vibrations is provided, which is connected with the device for detecting operating states, whereby vibrations perceptible by persons are generatable as a function of said operating states.

The invention further relates to a welding torch for a welding device for the execution of a welding process, including a device for generating vibrations perceptible by a person, said device for generating vibrations being connectable with a device for detecting operating parameters of the welding process.

A welding device used for the most diverse welding processes usually comprises an energy source and, preferably, a current source, optionally a supply line for a shielding gas as well as a welding torch, which is connected with the welding apparatus and energy source, respectively, via a hose pack. The hose pack contains both electric lines and the optional gas line as well as optional fluid lines to cool the welding torch. In manual welding methods, the welding torch is manually operated, and moved along the desired weld seam, by the welder. Since the welding torch is usually remote from the welding apparatus and connected with the latter via the hose pack, the welder is unable to read off welding parameters or operating states displayed on the welding apparatus, or set specific settings, during the welding process.

In order to improve this situation, methods for communicating between a welding apparatus and a welding torch are known, which enable the welder to obtain information on operating states even during a welding process. Similarly, it is possible for the welder to set, or change, specific settings on the welding apparatus by the aid of adjusting organs arranged on the welding torch.

It is, furthermore, known to detect a specific operating state and, in order to avoid long downtimes, automatically take the necessary steps so that the information on the operating state will rapidly reach a respectively provided receiver. WO 2004/004960 A1, for instance, describes a method for operating a welding device as well as a welding device, wherein the detected operating states are processed in accordance with stored instructions and compared with stored states, and automatically assigned messages are transmitted to external receivers as a function of the comparative results. It is thereby feasible to call a stockkeeper's attention to the fact that the stock of welding wire is running out and a new coil of welding wire will have to be provided.

Since the welder, during a welding process, turns his eyes on the welding site and the electric arc generated during the welding process, the welder is unable to read off displays during the welding process. To solve this problem, welding goggles in which texts or symbols are inserted are also offered. Since, as already pointed out, the welder is fully concentrated on the weld, such inserts will only be reasonable for the phases before and after the welding process proper.

The object of the present invention, therefore, consists in providing an above-identified method for operating a welding device, by which the welder in the event of a manual welding process, or the operator of a welding robot, or any other involved person, will be informed on specific operating states of the welding process virtually in real time during the welding process. The method is to be feasible as simply and cost-effectively as possible. Drawbacks of known methods are to be reduced or avoided.

Another object of the present invention consists in providing a welding device and a welding torch of the above-identified kinds, which are able to give feedback on operating states of the welding process to particular persons involved in the welding process, in particular the welder. The welding device or welding torch is to be constructed in a manner as simple and cost-effective as possible.

The object of the invention in method terms is achieved in that, for the generation of acoustic vibrations, the electric arc occurring in the welding process is modulated as a function of said operating states. By modulating the electric are with a vibration in the audible range, the electric arc can be employed as a loudspeaker. This offers the advantage that no structural changes need be made on the welding torch. The information to a person, in particular the welder, on specific operating states of the welding process is merely effected by modulating the electric arc.

In doing so, the electric arc is modulated as a function of said operating states, in particular by modulating the voltage or current generating the electric arc.

The object of the invention in method terms is also achieved in that mechanical vibrations perceptible by persons are generated as a function of said operating states.

Thus, any information on an operating state is communicated to a specific person, in particular the welder, during the welding process in the form of vibrations such that said person receives feedback on the executed welding process without having to turn away their eyes from the weld. The method, thus, serves to receive feedback virtually in real time on whether specific operating states have actually been observed. Likewise, the method according to the invention can be optimally used for training purposes, since persons will receive feedback on the welding processes executed by them. The term “operating states” is to encompass all operating parameters relevant to a welding process, such as, e.g., welding current, welding voltage, electric arc length, welding speed, gas flow, wire feed, temperature, cooling and many more. The present method will, above all, serve to give an alarm if a specific welding parameter or operating state has exceeded a limit value. The limit values may be absolute or relative limit values. Similarly, the method can also be employed to give feedback to involved persons, in particular the welder, on that a specific welding process has been initiated or a specific welding pattern has been run through. The present method for operating a welding device is, above all, applicable for manual welding methods, yet can also be used in automated robot welding processes. In this case, a person involved in a welding process would perceive the generated vibrations. The generated vibrations may be acoustic vibrations generated as a function of the respective operating states. The acoustic vibrations will be perceived by a person, in particular the welder, even if they do not turn their eyes away from the weld, as should be the case during welding.

The mechanical vibrations can, for instance, be generated by the aid of an ultrasonic generator. In order to enable the respective person, in particular the welder, to perceive the vibrations or oscillations., the respective vibration generator is preferably arranged on the welding torch. Likewise, it is, for instance, conceivable that the welder carries the vibration generator or oscillator on his wrist or stands on a support capable of being set in vibrations. What is important is that the person, in particular the welder, is informed on specific operating states via said vibrations or oscillations without having to turn away their eyes from the weld.

In order to increase the information content to be reproduced by the aid of generated vibrations, it is provided that the frequency and/or amplitude of the vibrations is varied as a function of said operating states. In this manner, some kind of encoding of the vibrations as a function of said operating states or operating parameters can be realized. The respective person is, thus, given feedback on specific operating states via the type of vibration.

Advantageously, the operating states are compared with stored instructions and the vibrations are generated as a function of the comparative results. In this manner, an alarm can, for instance, be given if defined limit values are exceeded. The stored instructions have to be appropriately adapted to the respective welding processes.

The object of the invention is also achieved by an above-identified welding device in which the device for generating vibrations is comprised of a modulator for modulating the welding voltage and/or the welding current in a manner that the electric arc occurring in the welding process is modulatable as a function of said operating states by vibrations that are acoustically perceptible by persons. As already mentioned above, this variant is particularly simple and cost-effective to produce, since no structural changes need be made at the welding torch and the available electric arc is used as a loudspeaker reproducing the information on the operating states. The connection between the device for generating vibrations and the device for detecting operating states can be realized via lines already provided between the welding torch and the welding apparatus.

The object of the invention is also achieved by an above-identified welding device in which the device for generating vibrations is comprised of a mechanical vibration generator.

In an advantageous manner, the mechanical vibration generator is arranged on the welding torch such that the welder is able to perceive the information on specific operating states through his hand. Naturally, it is also possible to arrange the mechanical vibration generator, for instance, in the form of a sleeve on the welder's wrist. However, this presupposes that the welder puts the mechanical vibration generator, for instance, on his wrist prior to starting the welding process.

According to a further characteristic feature of the invention, a device for storing instructions and a device for comparing the operating states with said instructions are provided, the device for generating vibrations being connected with the comparator device. Consequently, defined limit values for specific operating states can be deposited in the memory and an alert, i.e. the activation of the device for generating vibrations, can be triggered, if said limit values are exceeded or fallen short of. The device for storing instructions and the device for comparing the operating states with said instructions can be comprised of an arithmetic unit as is usually provided anyway in larger welding device.

The connection of the device for generating vibrations with said comparator device can be realized in a wireless manner or via lines. In the event of a line-conducted connection, available lines as are usually present in the hose pack between the welding torch and the welding apparatus can be employed.

In order to enable the encoding of the generated vibrations, means for changing the amplitude or the frequency of the generated vibrations are advantageously provided, which are connected with the detection device. Based on the detected operating states, the amplitude and/or frequency of the generated vibrations can, thus, be changed so as to transmit to a person and, in particular, the welder further information, for instance, on the extent by which the limit value of an operating state has been exceeded.

The object of the invention is also achieved by an above-identified welding torch for a welding device for carrying out a welding process, in which the device for generating vibrations is comprised of a modulator for modulating the welding voltage and/or the welding current, or a mechanical vibration generator.

The present invention will be explained in more detail by way of exemplary embodiments illustrated in the drawings.

Therein:

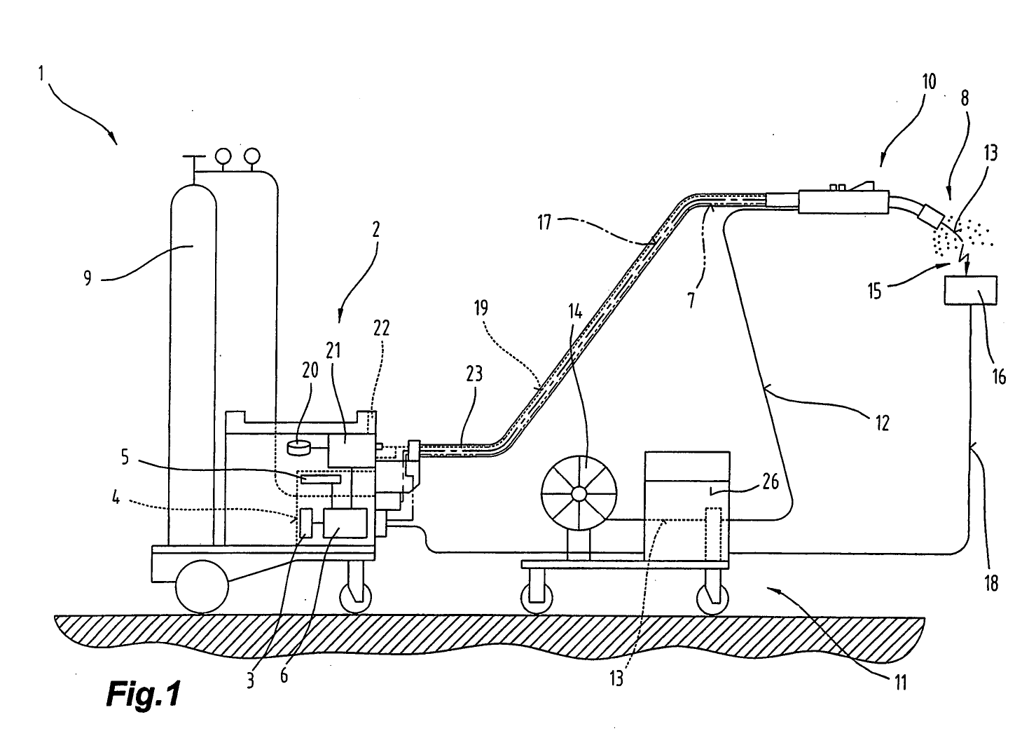

FIG. 1 represents a welding device in a simplified, schematic illustration;

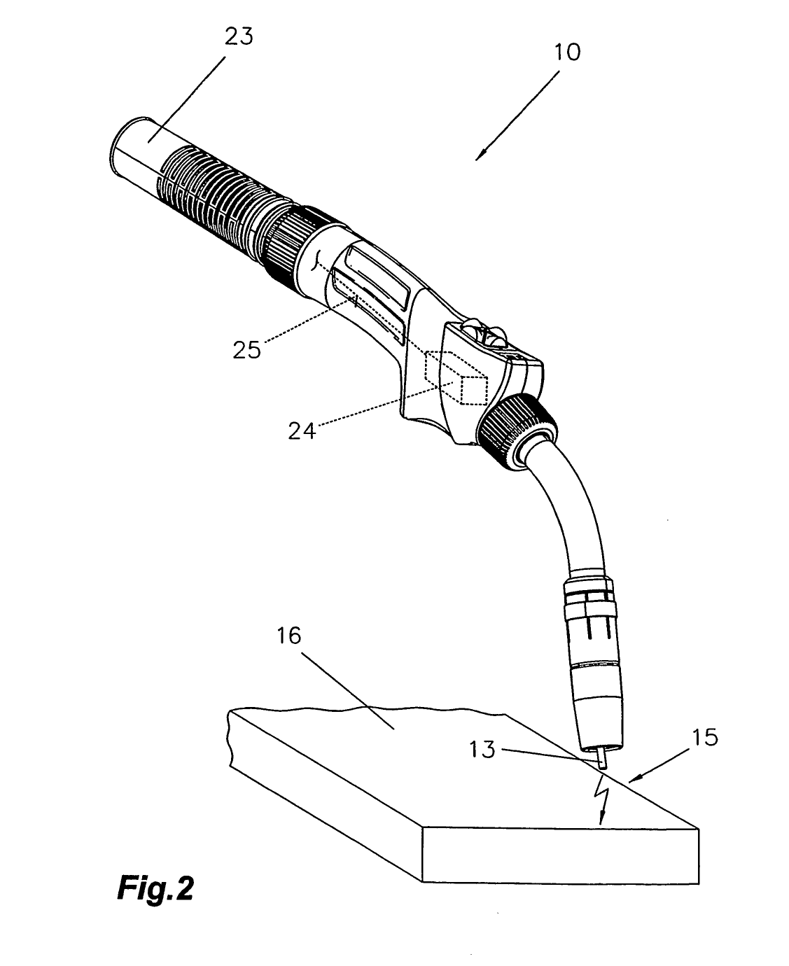

FIG. 2. illustrates a variant of a welding torch including a mechanical vibration generator;

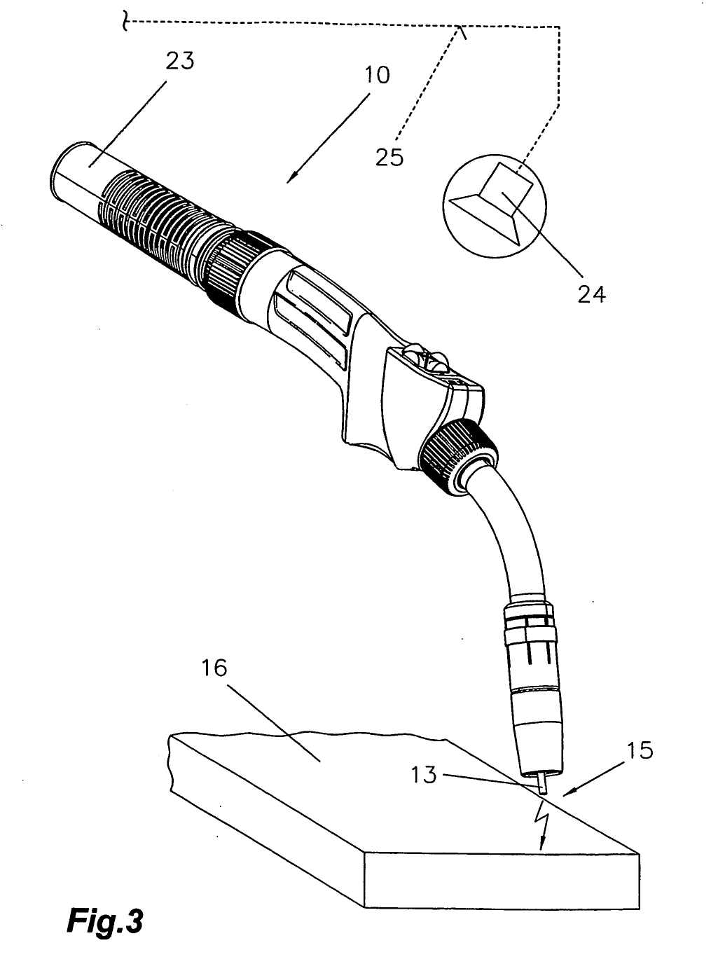

FIG. 3 shows a variant of a mechanical vibration generator as a separate unit; and

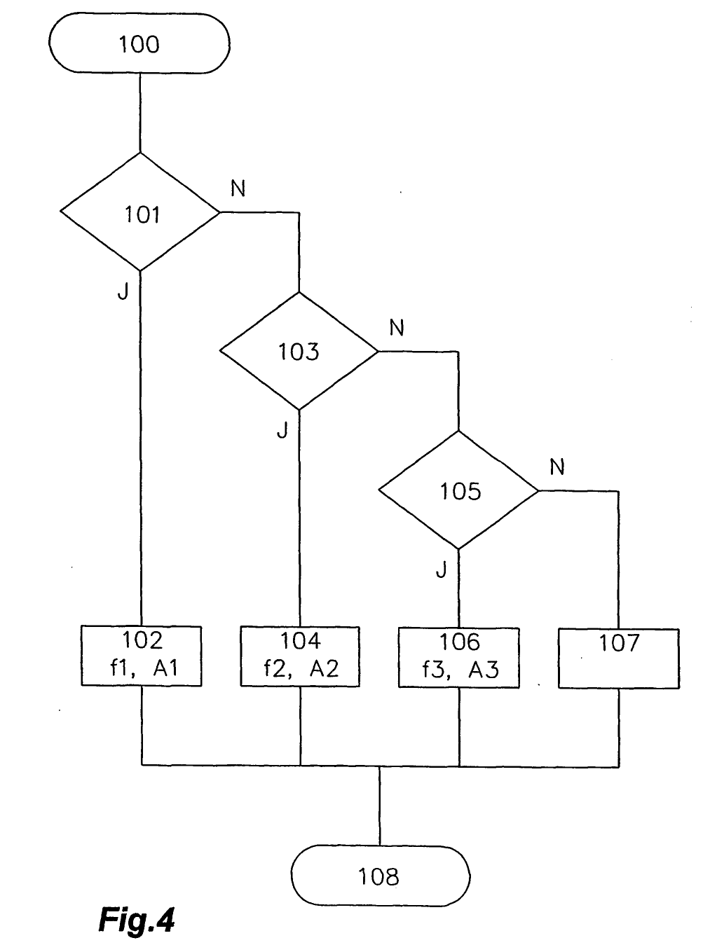

FIG. 4 is a block diagram illustrating the detection of specific operating states during a welding process.

FIG. 1 depicts a welding apparatus 1 for various welding methods such as, e.g., MIG (metal—inert gas) welding; MAG (metal—active gas) welding; WIG (Wolfram—inert gas) welding; TIG (tungsten—inert gas) welding or electrode welding methods, or the like. The welding device 1 comprises a welding apparatus 2 or energy source including a power element 3, a control and/or evaluation device 4. A gas reservoir 9 may contain a shielding gas used for the welding process, for instance, carbon dioxide, helium, argon or the like, which is fed to the welding torch 10 via a supply line 7.

In addition, a wire feeder 11, which is usually employed, for instance, in MIG/MAG welding, may be provided and controlled via the control and/or evaluation device 4. A welding wire 13 is fed from a feed drum 14 into the region of the welding torch 10 via a feed line 12. The wire feeder 11 may, of course, also be integrated in the welding apparatus 1.

The current I or voltage U required to build up an electric arc 15 between the welding wire 13 and a workpiece 16 is supplied via a welding line 17 from the power element 3 of the welding apparatus 2 to the welding torch 10 and welding wire 13, respectively. The workpiece 16 is also connected with the power element 3 of the welding apparatus 2 via a further welding line 18.

For cooling the welding torch 10, the welding torch 10 can be supplied with a cooling fluid via a cooling circuit 19. An input and/or output device 22, via which different welding parameters of the welding process can be set and displayed, is usually arranged on the welding apparatus 2.

The welding torch 10 is connected with the welding apparatus 2 via a hose pack 23. The hose pack 23 houses the individual lines for supplying the welding torch with electric energy, cooling fluid, shielding gas and the like. As a rule, a device 5 for detecting operating states of the welding process is provided in the welding apparatus 2. This device 5 for detecting operating states can be formed by different measuring instruments, sensors or the like, detecting, for instance, the welding voltage of the welding current, the length of the electric arc, the welding speed, the gas flow, the wire feed, the temperature or the cooling (not illustrated). It is, of course, also possible to integrate the device 5 for detecting operating states in the welding device 1. In this case, the device 5 for detecting operating states is, for instance, connected with the output jacks of the welding device such that the welding current and the welding voltage can, for instance, be taken up from there. In accordance with the invention, a device 6 for generating vibrations is provided, which may, for instance, be arranged in the welding apparatus 2 or on the welding torch 10. The device 6 for generating vibrations may, for instance, be comprised of a modulator for modulating the welding voltage U and/or the welding current I such that the electric arc 15 occurring during the welding process, as a function of the operating states, is modulatable by vibrations that are acoustically perceptible by persons. In doing so, it is also possible to generate visual feedbacks in the form of light pulses via the device 6, which means that feedbacks on specific process states can be given to the user due to differently bright electric arcs. In doing so, it is possible to combine acoustic and visual feedbacks. Moreover, a device 20 for storing instructions and a device 21 for comparing operating states with said instructions may be provided, the comparator device 21 being connected with the vibration-generating device 6. This connection may be realized in a wireless manner or in a line-conducted manner. By modulating the welding voltage U or the welding current I as a function of specific operating states, the welder is acoustically and/or visually notified of a specific operating state of the welding process via the electric arc 15.

FIG. 2 depicts a welding torch 10 in which the device 6 for generating vibrations is formed by a mechanical vibration generator 24 integrated in the welding torch 10. The welder, thus, receives feedback on the operating states during the welding process through the vibrations of the vibration generator 24. The vibration generator 24 may be arranged in the welding torch 10 in a manner that the housing has a thinner wall thickness in the region of the vibration generator 24 so as to enable the user to better perceive the vibrations. To this end, it is also possible to make the housing of the welding torch 10 flexible in the region of the vibration generator 24, i.e. that, for instance, a partial region of the housing comprises a recess closed by a leather or cloth cover, with the vibration generator 24 being arranged behind the same, in the interior of the welding torch 10. This provides an even better transmission of vibrations to the user.

In accordance with FIG. 3, the mechanical vibration generator 24 can also be available in the form of a wristband or the like, which is worn by the welder, or in the form of an external loudspeaker and connected via an appropriate line 25 with the device 5 for detecting the operating states. This line 25 may be formed by a line already provided in the hose pack 23. Such an external loudspeaker is advantageously arranged in the region of the welding screen. In this respect, it is also feasible to control the external vibration generator 24 by radio. This solution ensures that the user is able to position the vibration generator 24 on his body in the optimum manner possible so as to be able to perceive the vibrations well during welding without being at the same time too much disturbed. A substantial advantage of a solution comprising an external vibration generator 24 resides in that any desired welding device can be retrofitted with such a system, since only few modifications will be required on the unit for the connection of the external vibration generator 24. Otherwise, it will do to make a software update for its use.

FIG. 4 is a block diagram illustrating the method as it may proceed during a welding process. According to block 100, a program is, for instance, started, which proceeds in an arithmetic unit within the welding device 2. According to block 101, the power element 3 of the welding device 2 is checked for its function, and if there is an error, a defined vibration at a defined frequency f1 and amplitude Al will be emitted according to block 102. According to block 103, the welding voltage U is checked, and if a defined limit value is fallen short of, a vibration having a defined frequency f2 and amplitude A2 will be emitted according to block 104, which the welder will perceive. If a defined lower limit welding voltage is not fallen short of, an inquiry on whether a defined upper limit value for the welding voltage U has been exceeded will take place according to block 105. If it has been exceeded, the respective block 106 will generate a vibration at a frequency f3 and amplitude A3, which will be perceived by the welder. If the welding voltage U lies below the upper limit value, no vibration will be generated according to block 107. According to block 108, the program is concluded. FIG. 4 shows but one variant of a method according to the invention, yet this may be varied to correspond to different operating states or welding parameters. Also a change in the frequency f of the vibration as a function of the length of the electric arc is, for instance, feasible. From the frequency f or vibration tone, a deviation in the length of the electric arc can, thus, be concluded. The frequency f or tone, for instance, can be chosen the higher the smaller the length of the electric arc, and the lower the larger the length of the electric arc.

The use of the welding method according to the invention and the welding device and welding torch according to the invention is feasible both for training purposes and for quality assurance.

It is, furthermore, possible for the user to assign one or several parameters to the vibration generator via the input and/or output device 22 on the welding device 1. The user may, for instance, assign the parameter “electric arc length” for monitoring via the vibration generator such that the length of the electric arc will be monitored by the control device during the welding process and the vibration generator will be accordingly activated if a deviation has occurred. To this end, the user may determine upper and lower limit values to cause an activation of the vibration generator if said limit values are exceeded. In this exemplary embodiment, the user is thereby, for instance, enabled to keep a constant torch distance relative to the workpiece during manual welding, since a signal will be emitted via the vibration generator at a change of the distance, i.e. at a change in the length of the electric arc, which will be recognized by the user to immediately carry out a correction.

To this end, it is also possible to provide special sequence routines via which noise factors can be taken into account. This may, for instance, be realized in that, at the occurrence of a short-circuit when monitoring the length of the electric arc, the vibration generator is not activated at once, but only after the expiration of a preset period of time.

Furthermore, the vibration generator can also be coupled with external monitoring components, which means that, for instance, with a welding speed monitoring device, which may, however, also be integrated in the welding device, the vibration generator will be assigned. to the same so as to enable the user to be informed via the vibration generator during welding on whether he makes the weld too quickly or too slowly. Another application would comprise the notification of the user on forthcoming failures via the vibration generator. The user could, for instance, be informed that the shielding gas and/or the welding wire would shortly run out or that the temperature would rise to a critical range.

It is essential that different parameters, failures and/or operating states are monitored and output via the vibration generator during a welding process without forcing the user to let the welding process out of his sight. Basically, the various information transmissions are performed by the vibration generator at different frequencies so as to enable their unambiguous allocation or unambiguous recognition by the user. To this end, the user may determine on his own which frequency to choose for which parameter, operating state and/or failure so as to be able to receive and recognize an unambiguous feedback signal during the welding process.

It is further possible to form the feedback signal, which is generated by the vibration generator during the welding process, by a tone sequence, e.g. three times consecutively the same tone, via the tone of the electric arc or by a tone pattern, e.g., different consecutive tones.

1. A method for operating a welding device for the execution of welding processes, including a welding apparatus and a welding torch, wherein operating states of the welding processes are detected and vibrations perceptible by persons are generated as a function of said operating states, wherein, for the generation of acoustic vibrations, the electric arc occurring in the welding process is modulated as a function of said operating states.

2. A method according to claim 1, wherein the welding current and/or the welding voltage are modulated as a function of said operating states.

3. A method for operating a welding device for the execution of a welding process, including a welding apparatus and a welding torch, wherein operating states of the welding process are detected and vibrations perceptible by persons are generated as a function of said operating states, wherein mechanical vibrations are generated as a function of said operating states.

4. A method according to claim 3, wherein the mechanical vibrations are generated by the aid of an ultrasonic generator.

5. A method according to claim 1, wherein the frequency of the vibrations is varied as a function of said operating states.

6. A method according to claim 1, wherein the amplitude of the vibrations is varied as a function of said operating states.

7. A method according to claim 1, wherein the operating states are compared with stored instructions and the vibrations are generated as a function of the comparative results.

8. A welding device for the execution of a welding process, including a welding apparatus (2) and a welding torch (10) connected with the welding apparatus (2) as well as a device (5) for detecting operating states of the welding process, wherein a device (6) for generating vibrations is provided, which is connected with the device (5) for detecting operating states, whereby vibrations perceptible by persons are generatable as a function of said operating states, wherein the device (6) for generating vibrations is comprised of a modulator for modulating the welding voltage (U) and/or the welding current (I) in a manner that the electric arc (15) occurring in the welding process is modulatable as a function of the operating states by vibrations that are acoustically perceptible by persons.

9. A welding device for the execution of a welding process, including a welding apparatus (2) and a welding torch (10) connected with the welding apparatus (2) as well as a device (5) for detecting operating states of the welding process, wherein a device (6) for generating vibrations is provided, which is connected with the device (5) for detecting operating states, whereby vibrations perceptible by persons are generatable as a function of said operating states, wherein the device (6) for generating vibrations is comprised of a mechanical vibration generator (24).

10. A welding device according to claim 9, wherein the mechanical vibration generator is arranged on the welding torch (10).

11. A welding device according to claim 1, wherein a device (20) for storing instructions and a device (21) for comparing the operating states with said instructions are provided, and that the device (6) for generating vibrations is connected with the comparator device (21).

12. A welding device according to claim 11, wherein the device (6) for generating vibrations is connected with the comparator device (21) in a wireless manner.

13. A welding device according to claim 11, wherein the device (6) for generating vibrations is line-connected with the comparator device (21).

14. A welding device according to claim 8, wherein a means for changing the amplitude (A) of the generated vibrations is provided, which is connected with the detection device (5).

15. A welding device according to claim 8, wherein a means for changing the frequency (f) of the generated vibrations is provided, which is connected with the detection device (5).

16. A welding torch for a welding device for the execution of a welding process, including a device (6) for generating vibrations perceptible by a person, said device (6) for generating vibrations being connectable with a device (5) for detecting operating parameters of the welding process, wherein the device (6) for generating vibrations is comprised of a modulator for modulating the welding voltage (U) and/or the welding current (I).

17. A welding torch for a welding device for the execution of a welding process, including a device (6) for generating vibrations perceptible by a person, said device (6) for generating vibrations being connectable with a device (5) for detecting operating parameters of the welding process, wherein the device (6) for generating vibrations is comprised of a mechanical vibration generator.
